(19) United States
(12) Patent Application Publication
(10) Pub. No.: US 2026/0268092 A1
(43) Pub. Date: Sep. 10, 2026

(54) METHOD AND APPARATUS FOR GENERATING PLOT IN MINIATURE THEATER INTELLIGENT MACHINE, DEVICE, MEDIUM, AND PRODUCT

(71) Applicant: Zhejiang Normal University, Jinhua City (CN)

(72) Inventors: Jiaying REN, Jinhua City (CN); Yici MA, Jinhua City (CN); Yongfeng LIANG, Jinhua City (CN)

(21) Appl. No.: 19/201,134

(22) Filed: May 7, 2025

(30) Foreign Application Priority Data
Mar. 4, 2025 (CN) 202510247316.9

(51) Int. Cl. G06F 40/40; G06F 40/166; G06F 40/279; G06K 7/10; H04B 5/72

(52) U.S. Cl. CPC G06F 40/40; G06F 40/166; G06F 40/279; G06K 7/10297; H04B 5/72

(57) ABSTRACT

A method and an apparatus for generating a plot in a miniature theater intelligent machine, a device, a medium, and a product are provided. The method includes: performing word segmentation on a plot text at a current moment to generate multiple words; transforming the multiple words by bidirectional encoder representations from Transformers to generate word vectors corresponding to respective words; setting the word vectors as feature vectors corresponding to the plot text at the current moment; inputting the feature vectors and contextual information at the current moment into a trained deep learning model to determine a plot text at a next moment; and setting the plot text at the next moment as the plot text at the current moment, and returning to the step of performing word segmentation on a plot text at a current moment to generate multiple words.

### CROSS-REFERENCE TO RELATED APPLICATION

This application claims the benefit of and priority to Chinese Patent Application No. 202510247316.9, filed on Mar. 4, 2025, which is incorporated by reference herein in its entirety.

### TECHNICAL FIELD

The present disclosure relates to the field of artificial intelligence, and in particular to a method and an apparatus for generating a plot in a miniature theater intelligent machine, a device, a medium, and a product.

### BACKGROUND

Ordinary educational toys often focus on specific subjects or skills, leading to a situation that the children are trained only in a particular area, lacking diversity and comprehensiveness. Meanwhile, these toys, due to the single form, lack enough long-term attraction for the children, making the educational effect weakened. Meanwhile, the traditional story toys are the least attractive to children due to their relatively weak interactivity and creativity, and the certainty and singleness of stories may make children lose interest in the same story content quickly, and thus the traditional story toys cannot meet the needs of long-term play.

For the problems above, there is an urgent need of a method for generating a plot in a miniature theater intelligent machine, which can achieve the diversified and personalized interactive experience of plot texts, thus improving the interest, learning and participation experience of the children.

### SUMMARY

An objective of the present disclosure is to provide a method and an apparatus for generating a plot in a miniature theater intelligent machine, a device, a medium, and a product, which can solve the problems of single plot text generation and poor interactivity of the miniature theater intelligent machine in the related art.

To achieve the objective above, the present disclosure employs the following technical solutions.

In a first aspect, the present disclosure provides a method for generating a plot in a miniature theater intelligent machine, including:
performing word segmentation on a plot text at a current moment to generate multiple words, where the plot text includes an educational story or game plotline, a plot category and personage dialogue corresponding to the plot category;
transforming the multiple words by Bidirectional Encoder Representations from Transformers to generate word vectors corresponding to respective words;
setting the word vectors corresponding to the respective words as feature vectors corresponding to the plot text at the current moment;
inputting the feature vectors corresponding to the plot text at the current moment and contextual information at the current moment into a trained deep learning model to determine a plot text at a next moment, where the contextual information at the current moment includes a historical choice of a user at the current moment, an emotional state of a character at the current moment, and a real-time operation instruction of the user at the current moment, and the real-time operation instruction includes a voice instruction and a touch instruction; and
setting the plot text at the next moment as the plot text at the current moment, and returning to the step of “performing word segmentation on a plot text at a current moment to generate multiple words”.

In a second aspect, the present disclosure provides an apparatus for generating a plot in a miniature theater intelligent machine, including:
the miniature theater intelligent machine, a far infrared induction flashlight, a projector, and a power module.

The far infrared induction flashlight is provided with a card slot; the card slot is used for the insertion of a character near field communication (NFC) card, and the character NFC card is used for storing character information. The character information includes the personage dialogue, a scene corresponding to the personage dialogue, and personage information.

The far infrared induction flashlight is configured to read the character NFC card to trigger a corresponding plot, and irradiate a personage on a screen of the miniature theater intelligent machine by a far infrared ray to trigger a plot text corresponding to the personage.

The miniature theater intelligent machine includes a sensor, and a loudspeaker. The sensor is configured to sense an operation instruction of a user, and the loudspeaker is configured to play a sound effect in the plot.

The miniature theater intelligent machine is configured to execute the method for generating the plot in the miniature theater intelligent machine in the first aspect.

The projector is configured to project a plot scene corresponding to the plot text at the next moment generated by the miniature theater intelligent machine onto the screen.

The power module is configured to supply power to the miniature theater intelligent machine, the far infrared induction flashlight, and the projector.

In a third aspect, the present disclosure provides a computer device, including a memory, a processor, and a computer program stored in the memory and executable on the processor. The processor, when executing the computer program, implements the method for generating the plot in the miniature theater intelligent machine above.

In a fourth aspect, the present disclosure provides a computer readable storage medium, having a computer program stored therein, where the computer program, when executed by a processor, implements the method for generating the plot in the miniature theater intelligent machine above.

In a fifth aspect, the present disclosure provides a computer program product, including a computer program. The computer program, when executed by a processor, implements the method for generating the plot in the miniature theater intelligent machine above.

According to specific embodiments of the present disclosure, the present disclosure has the following technical effects.

The present disclosure provides a method and an apparatus for generating a plot in a miniature theater intelligent machine, a device, a medium, and a product. In present disclosure, word segmentation is performed on a plot text at a current moment to generate multiple words, where the plot text includes an educational story or a game plotline, a plot category, and personage dialogue corresponding to the plot category, and then the multiple words are transformed by Bidirectional Encoder Representations from Transformers to generate word vectors corresponding to respective words, which can achieve the preprocessing of the plot text for laying the foundation for a subsequent deep learning model to accurately generate the plot text at the next moment. Further, the word vectors corresponding to the respective words are used as feature vectors corresponding to the plot text at the current moment, all the choices of a user within the current moment, an emotional state of a character and a real-time operation instruction of the user are input into a trained deep learning model to determine a plot text at a next moment, and the plot text at the next moment is used as the plot text at the current moment to achieve the coherence and interest of the plot. In present disclosure, a voice instruction and a touch instruction of the user are combined, and the voice interaction with users, especially for users such as children, through the plot of the story or the game can enhance the sense of participation of the children. Moreover, the children are enabled to freely adjust the plot in real time according to their own operation instructions during play to achieve multi-module human-computer interaction, thus creating their own unique story plot, ensuring interactivity and creativity, meeting the needs of personalized creation, and learning the knowledge in the educational story at the same time.

### BRIEF DESCRIPTION OF THE DRAWINGS

To describe the technical solutions in the embodiments of the present disclosure or in the prior art more clearly, the following briefly introduces the accompanying drawings required for describing the embodiments. Apparently, the accompanying drawings in the following description show merely some embodiments of the present disclosure, and those of ordinary skill in the art may still derive other drawings from these accompanying drawings without creative efforts.

FIG. 1 is a flow diagram of a method for generating a plot in a miniature theater intelligent machine according to an embodiment of the present disclosure;

FIG. 2 is a flow block diagram of an apparatus for generating a plot in a miniature theater intelligent machine according to an embodiment of the present disclosure;

FIG. 3 is an operation diagram of an apparatus for generating a plot in a miniature theater intelligent machine according to an embodiment of the present disclosure; and

FIG. 4 is a structural detail diagram of an apparatus for generating a plot in a miniature theater intelligent machine according to an embodiment of the present disclosure.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the scope of protection of the present disclosure.

In order to make the objectives, features and advantages of the present disclosure more clearly, the present disclosure is further described in detail below with reference to the accompanying drawings and specific embodiments.

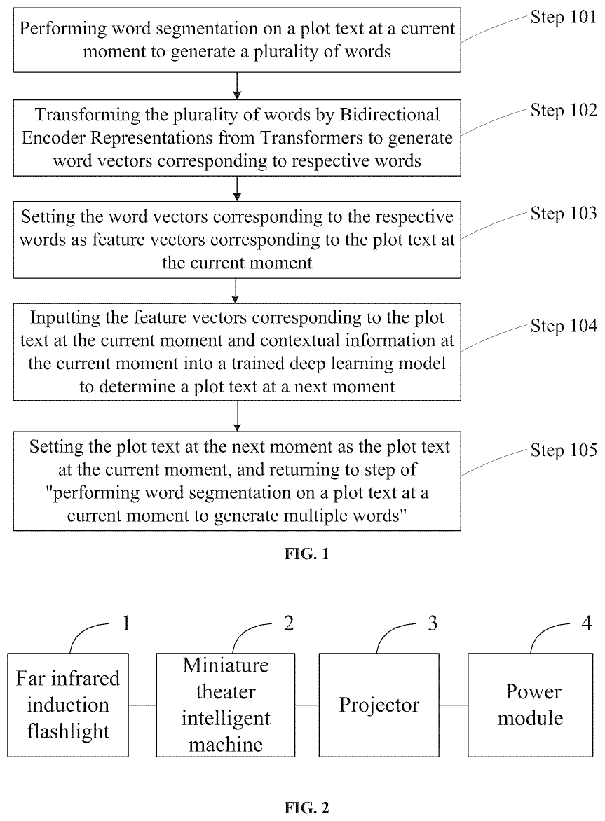

As shown in FIG. 1, the present disclosure provides a method for generating a plot in a miniature theater intelligent machine, including steps 101-105.

In step 101, the word segmentation is performed on a plot text at a current moment to generate multiple words, where the plot text includes an educational story or game plotline, a plot category and personage dialogue corresponding to the plot category.

In step 102, the multiple words are transformed by Bidirectional Encoder Representations from Transformers to generate word vectors corresponding to respective words.

In step 103, the word vectors corresponding to the respective words are used as feature vectors corresponding to the plot text at the current moment.

Specifically, for steps 101 to 103, the process of preprocessing the plot text is as follows.

A large number of plot texts, including stories, plotlines, personage dialogue, etc., are collected. The preprocessing includes removing noisy points (e.g., irrelevant characters, special symbols), performing normalization processing, word segmentation, part-of-speech tagging, semantic parsing, etc. After preprocessing, the text data is transformed into word vectors or a serialized form.

To make the model understand and generate a reasonable plot, the plot text may need to be annotated. For example, a speaker is labeled for each dialogue segment, a time sequence is labeled for the story or game plotline, and an emotional trend is annotated for the plotline, etc.

Before inputting the data into the deep learning model, the text data also needs to be subjected to denoising (e.g., irrelevant characters, special symbols), standardization (e.g., uniform uppercase or lowercase processing), word segmentation, part-of-speech tagging, semantic parsing, etc. For a Recurrent Neural Network (RNN) or other deep learning models, the text often needs to be transformed into word vectors or the sequenced form. In the present disclosure, the Bidirectional Encoder Representations from Transformers (BERT) are used for transforming the plot text into the feature vectors, which is specifically as follows.

Word segmentation: the text is segmented into words or sub-word units. For example, for a sentence “The cat sat on the mat”, a result of word segmentation is as follows: [“The”, “cat”, “sat”, “on”, “the”, “mat” ].

Word embedding transformation: each word or sub-word unit is transformed into a corresponding word vector by BERT. For example, BERT can generate vector representation with a fixed length for each word, and these vectors can capture the semantic and context information of the words.

Feature vector representation: the final processed data is represented in the form of feature vector. The word vector of each word is used as an input of the model to form a sequenced vector sequence. For example, after the sentence “The cat sat on the mat” is subjected to BERT processing, the word vector of each word is represented as follows:
The: [0.1, 0.2, 0.3, . . . , 0.9];
cat: [0.4, 0.5, 0.6, . . . , 0.1];
sat: [0.7, 0.8, 0.9, . . . , 0.2];
on: [0.1, 0.1, 0.1, . . . , 0.3];
the: [0.2, 0.3, 0.4, . . . , 0.5];
mat: [0.3, 0.4, 0.5, . . . , 0.6].

Inputting into deep learning model: the transformed word vector sequences are input into the recurrent neural network or other deep learning models for a plot generation task. The model is configured to capture the semantic in the text and the context information through these feature vectors, thus generating coherent and logical plot content.

In step 104, the feature vectors corresponding to the plot text at the current moment and contextual information at the current moment are input into the trained deep learning model to determine a plot text at a next moment, where the contextual information at the current moment comprises a historical choice of a user at the current moment, an emotional state of a character at the current moment, and a real-time operation instruction of the user at the current moment, and the real-time operation instruction includes a voice instruction and a touch instruction.

In step 105, the plot text at the next moment is used as the plot text at the current moment, and then it is returned to the step of “performing word segmentation on a plot text at a current moment to generate multiple words”.

During actual application, the story plot is enriched through multi-modal human-computer interaction and artificial intelligence plot generation technology, making each game experience unique. Meanwhile, the sense of participation of the children can be enhanced by means of a mystery-themed game and a voice interaction mode. Support for customizing game plots allows the children to create unique and personalized stories while playing, and personalized creative demands are satisfied.

In some embodiments, before step 104, the method further includes constructing a deep learning model. The training process of the deep learning model specifically includes: generating a historical plot text at a starting moment by setting all historical choices of a historical user, an emotional state of a historical character and a operation instruction of the historical user obtained at the starting moment as contextual information; setting the historical plot text at the starting moment as the plot text at the current moment; inputting the feature vectors corresponding to the plot text at the current moment and historical contextual information into the deep learning model to output a plot text at a next moment; and training the deep learning model with the goal of minimizing a difference between the plot category of the historical plot text at the next moment and a real plot category corresponding to the operation instruction of the user to obtain a trained deep learning model.

The recurrent neural network is used as the deep learning model, which is one of the commonly used sequence models, particularly with a long short-term memory network or a gated recurrent unit as a foundational model. For example, the long short-term memory network is suitable for processing time series data or a task that depends on the context. In the plot generation, the long short-term memory network or the gated recurrent unit is a common variant of the recurrent neural network, which can process a long-distance dependence relationship better to avoid the problem of gradient disappearance.

During training, the input of the deep learning model is usually a preceding text or a certain segment of a story, and the output of the deep learning model is the next sentence or event predicted by the model. To generate a continuous plot, the model can gradually generate a complete plot by generating a part of content and setting this part of content as the input of the next step.

In a forward propagation stage, a probability distribution of the output is gradually calculated through passing the input data through respective layers (including an embedding layer, a recurrent neural network layer and an output layer) of the model. For each time step, the deep learning model can predict an output at the next time step according to the current input and a previous hidden state. In the task of generating the plot text, a cross entropy loss function is usually used to measure a gap between the plot text generated by the deep learning model and the real plot text. The cross entropy loss function can effectively balance a probability distribution difference between a predicted word and a target word. The model is trained through forward propagation and back propagation algorithms.

A plot generation process of the deep learning model is as follows.

### 1. Plot Generation According to Contextual Information

When a story or game is started, the deep learning model will receive the current contextual information as an input, which may include a current state of the game, choice history of a user, an emotional state of a character, etc., i.e., all the choices of the user within the current moment, the emotional state of the character and a real-time operation instruction of the user. The deep learning model can generate an appropriate plot by integrating these pieces of contextual information.

### 2. Recursive Generation

The plot generation is general a recursive process. The model can generate a line of dialogue or an event, and takes this line of dialogue or event as an input of the next step to continuously generate the subsequent plot content. This method can ensure that the plot is coherent and logical, with the specific implementation as follows.

Initial input: when the story or game is started, the deep learning model receives an initial input, such as background setting of the story or game, the character information or the choice of the user. These pieces of information form a starting point of text generation.

Generation process: the deep learning model generates a first line of dialogue or a first event according to the initial input. The generated content is not only based on a predetermined plot trend, but also can be dynamically adjusted according to a behavior of the user. For example, if the user selects a specific option, the model can generate a dialogue or event related to the option.

The generated dialogue or event is used as the input of the next step to continuously generate the subsequent plot content. Through recursive generation, the deep learning model can ensure the coherence and logicality of the plot. The plot text generated in each step is based on a result of the previous step, making the whole plot form an organic whole. For example, if the dialogue of one character is generated in the previous step, the action of the character or the response of another character can be generated in the next step.

In addition, the deep learning model can adjust the generated plot text in real time through a real-time operation instruction (e.g., touch screen selection or voice instruction) of the user. The generated plot text not only depends on the predetermined plot trend, but also can be dynamically adjusted according to the behavior of the user to achieve personalized and interactive plot experience, with the specific implementation as follows.

Real-time input: the user can interact with the intelligent machine through screen touching, voice instruction or option selection and the like in the game process. These inputs will be received and processed in real time by the deep learning model.

Condition determination: the deep learning model can determine conditions according to the real-time operation instruction of the user to determine the plot trend in the next step. For example, if the user selects a specific option, the model will determine whether the option triggers a specific plot branch or not.

Dynamic adjustment: the deep learning model can dynamically adjust the generated plot content according to a result of condition determination. For example, if the user selects a positive option, the model may generate a positive plot development; and if the user selects a negative option, the model may generate a negative plot development.

Personalized experience: the model can provide personalized plot experience for each user through real-time adjustment. The choice and operation of each user will affect the development of the plot, making the game have higher replay value and attraction.

In some embodiments, after training the deep learning model with the goal of minimizing a loss between the plot text at the next moment and a real plot text corresponding to the operation instruction of the user to obtain a trained deep learning model, the method further includes: acquiring a plot scene generated by the plot text at the next moment; optimizing the plot scene based on a structural similarity index measure or a peak signal-to-noise ratio to determine an optimized plot scene; and taking the optimized plot scene as the plot scene.

In some embodiments, optimizing the plot scene based on a structural similarity index measure or a peak signal-to-noise ratio to determine an optimized plot scene specifically includes: determining the structural similarity index measure based on the mean, standard deviation and covariance of the plot scene, and the mean, standard deviation and covariance of the original plot scene structure, and maximizing the structural similarity index measure to determine the optimized plot scene; or determining the peak signal-to-noise ratio based on the maximum predetermined pixel value of the plot scene and the mean variance between the plot scene and the original plot scene structure, and maximizing the peak signal-to-noise ratio to determine the optimized plot scene.

Specifically, the structural similarity index measure (SSIM) is used to evaluate the structural similarity between the generated plot scene and the target scene (original plot scene structure), which considers the brightness, the contrast and the structural information of the image. High SSIM value indicates that the generated plot scene x and the original plot scene structure y are similar and visually coherent. The SSIM formula is as follows:

$$SSIM ( x , y ) = \frac{( 2 {μ}_{x} {μ}_{y} + {c}_{1} ) ( 2 {σ}_{xy} + {c}_{2} )}{( {μ}_{x}^{2} + {μ}_{y}^{2} + {c}_{1} ) ( {σ}_{x}^{2} + {σ}_{y}^{2} + {c}_{2} )} ,$$

where μₓ and μ_{y} are means of x and y, respectively, σₓ and σ_{y} are standard deviations of x and y, respectively, σ_{xy} is a covariance of x and y, and c₁ and c₂ are small constants for stable denominators.

In actual application, by comparing a calculated value of the structural similarity index measure between the plot scene and the original plot scene structure with an SSIM predetermined value, a difference between the SSIM predetermined value and the calculated value is minimized based on the deep learning model to obtain the final plot scene.

Specifically, a peak signal-to-noise ratio (PSNR) is mainly used to measure a difference between the generated plot scene x and the original plot scene structure y, especially the influence of the noise. The higher the PSNR value, it is indicated that the closer the quality of the generated scene is to the original scene. The PSNR formula is as follows:

$$PSNR = 10 {log}_{10} ( \frac{{MAX}_{I}^{2}}{MSE} ) ,$$

where

$${MAX}_{I}^{2}$$

is the maximum predetermined pixel value of x, and MSE is a mean square error of x and y. Specifically,

$${MAX}_{I}^{2}$$

is the maximum pixel value supported by an image format (e.g., 255 for an 8-bit image). MSE is a mean square error of the generated scene x and the original scene y, which is calculated by a pixel-by-pixel difference.

In actual application, by comparing the peak signal-to-noise ratio corresponding to the plot scene with the predetermined peak signal-to-noise ratio, the difference between the peak signal-to-noise ratio and the predetermined peak signal-to-noise ratio is minimized based on the deep learning model to obtain the final plot scene.

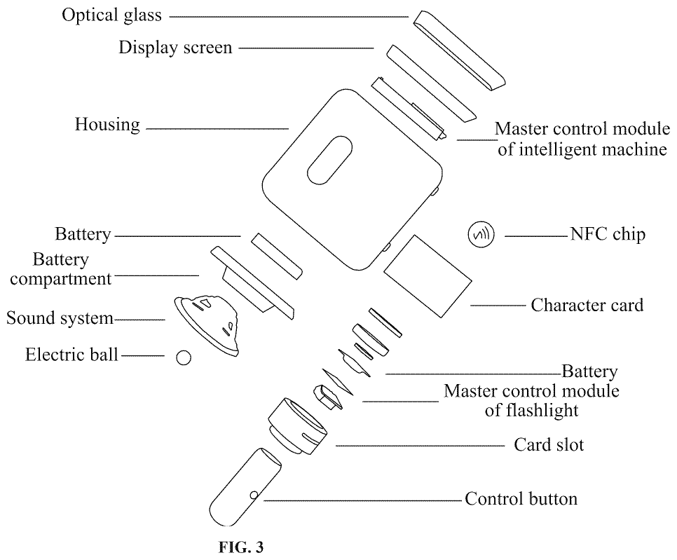

Referring to FIG. 2, an apparatus for generating a plot in a miniature theater intelligent machine includes:

a far infrared induction flashlight 1, a miniature theater intelligent machine 2, a projector 3, and a power module 4. The far infrared induction flashlight 1 is provided with a card slot; the card slot is used for the insertion of a character NFC card, and the character NFC card is used for storing character information. The character information includes personage dialogue, a scene corresponding to the personage dialogue, and personage information. The far infrared induction flashlight 1 is configured to read the character NFC card to trigger a corresponding plot, and irradiate a personage on a screen of the miniature theater intelligent machine 2 by a far infrared ray to trigger a plot text corresponding to the personage. The miniature theater intelligent machine 2 includes a sensor, and a loudspeaker. The sensor is configured to sense an operation instruction of a user, and the loudspeaker is configured to play a sound effect in the plot. The miniature theater intelligent machine 2 is configured to execute the method for generating a plot in a miniature theater intelligent machine. The projector 3 is configured to project a plot scene corresponding to a plot text generated by the miniature theater intelligent machine 2 onto the screen. The power module 4 is configured to supply power to the miniature theater intelligent machine 2, the far infrared induction flashlight 1, and the projector 3.

In some embodiments, the apparatus for generating a plot in a miniature theater intelligent machine further includes a communication module. The communication module is arranged within the miniature theater intelligent machine. The communication module is in wireless communication with an external terminal for data transmission. The external terminal is configured for a user to send a real-time operation instruction.

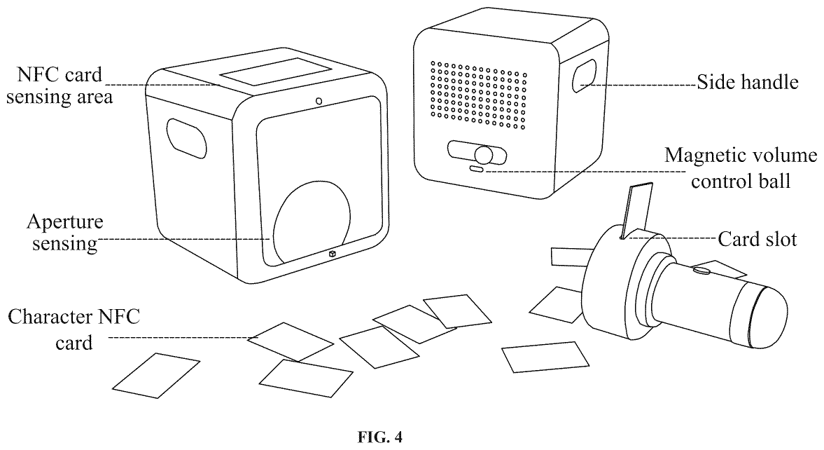

Referring to FIG. 3 and FIG. 4, the miniature theater intelligent machine, i.e., a main body device (a sugar cube theater box) includes a core processing unit, which is responsible for plot generation and interactive control.

The far infrared induction flashlight is configured to read character card information and irradiate the main body device to trigger interaction;

The character card is inserted into the flashlight for selecting a character and triggering a corresponding plot.

The sensor and an actuator are configured to sense a user operation (touch, voice, etc.) and output plot content (projection, sound, etc.), respectively.

The projector is configured to project a generated plot scene onto a screen.

The loudspeaker is configured to play a sound effect in the plot.

The power supply is configured to supply power for the whole system.

The communication module is configured to communicate with an external device (e.g., application (APP)) for data transmission.

The miniature theater intelligent machine further includes an electric ball, a sound system, a battery compartment, a side handle, a housing, a master control module of the miniature theater intelligent machine, a display screen, and optical glass. The electric ball is configured to adjust the volume of the intelligent machine. The sound system is configured to provide excellent tone quality. A chargeable lithium battery is arranged in the battery compartment. The side handle is convenient for a child to take. The housing is a concise sugar cube shape. A master control module of the intelligent machine, after receiving the character information, makes conditional determination through an AI model (i.e., the deep learning model) to determine the behavior intention of the user and trigger the corresponding plot. The display screen provides a 16-bit image, and the optical glass is configured to filter the blue light to protect eyesight of the children.

An NFC card sensing area is located right above the miniature theater intelligent machine, and is configured to obtain contextual information corresponding to the card.

The far infrared induction flashlight includes a control button, a card slot, a master control module of the flashlight, a character card, and an NFC card. The control button is a switch and projection of the flashlight. The character card has a built-in NFC chip. When the character card is inserted into the card slot, the master control module of the flashlight can read the information in the character card and project the character on the screen of the intelligent machine by a far infrared induction technology.

All components are connected by an internal circuit and a wireless communication mode to operate cooperatively. The power module supplies power, the main body device is started, and the communication module is connected to the APP. The user inserts the character card into the flashlight, and the flashlight reads the information and transmits the information to the main body device through a far infrared ray to trigger the generation of the plot. The main body device is configured to process the information to generate the plot content, and output the generated plot content through a projector and a loudspeaker. The sensor is configured to sense an operation of the user and feed the operation back to the main body device to adjust the plot in real time. The power module supplies power, and the communication module is connected to the external APP to transmit data, thus achieving the interactive story game.

Embodiment 2: An educational story in the present disclosure can be based on a historical blueprint of The Riverside Scene at Qingming Festival, with “playing games+finding clues+learning knowledge” as the core design thread, aiming at creating products with interactive experience and aesthetic education value in Song Dynasty for children. In the aspect of appearance design, the concise square shape of sugar cube is used as the miniature theater intelligent machine to achieve the human-computer interaction scene.

In step 1, the “Sugar Cube” theater box is turned on. Specifically, an executive body is a user (child). Technical details are as follows. When the user turns on the “Sugar Cube” theater box, the device automatically starts Augmented Reality (AR), Artificial Intelligence (AI), Computer Vision (CV) and Automatic Speech Recognition (ASR) techniques. The far infrared induction flashlight is configured to irradiate the theater box, and different scenes in the Riverside Scene at Qingming Festival are displayed on the screen.

In step 2, the character card is inserted for interaction. Specifically, the executive body is the user (child). Technical details are as follows. Hardware platform construction: an Arduino embedded system is selected to construct a corresponding hardware platform. Connection of sensor and actuator: multiple sensors, such as an infrared sensor, a camera, a microphone, are installed on a square block (the miniature theater intelligent machine) and the flashlight, and are configured to sense behavior and environment information of the user. Programming: a programming language is used to write programs to achieve the collection and processing of sensor data as well as the control of the actuator. Condition determination and plot triggering: after the theater box receives the character information, an AI model is configured to perform condition determination to determine the behavior intention of the user and trigger the corresponding plot.

In step 3, the artificial intelligence plot is generated. Specifically, the executive body is a deep learning model, e.g., an AI model. Technical details are as follows. Data set preparation: a large amount of plot content is collected, including related stories, plotlines, personage dialogues, etc. The data is preprocessed, including denoising, standardizing, word segmentation, part-of-speech tagging, semantic parsing, and other steps, and the text data is finally transformed into word vectors or a serialized form. Model training: a recurrent neural network (RNN) is selected, especially a long short-term memory (LSTM) network or a gated recurrent unit (GRU), which is configured to process time series data and long-range dependencies. The model is trained through forward propagation and back propagation algorithms, which can generate reasonable plot content according to the input data. Plot generation: during game, the AI model can generate new plot content (i.e., plot text) according to the current game scene and the historical choice of the user. Specifically, the model will generate corresponding dialogues and events according to the input context information, and show the corresponding dialogues and events to the user through a multimedia interactive projection technology. Optimization and adjustment: the generated plot is evaluated and optimized through a machine learning algorithm. For example, the structural similarity index measure and the peak signal-to-noise ratio and other indexes are used to evaluate the quality of the plot scene, and the quality of the plot scene can be adjusted according to the feedback of the user to improve the coherence and interesting of the plot.

In step 4, the apparatus is used in cooperation with the APP of the external terminal. Specifically, the theater box is used with the APP of the external terminal at the same time, and the level setting and storyline adjustment can be carried out according to the understanding ability of the children to increase exploration fun of the children. Specifically, the APP can provide personalized level design and plot content according to the age, interest and learning progress of the children, making the game better meet the needs of the children.

The present disclosure fuses four media perception technologies, e.g., augmented reality, artificial intelligence, computer vision and voice recognition, and combines a multimedia interactive projection technology. The far infrared induction flashlight is configured to irradiate the “sugar cube” to trigger the scene linkage, thus promoting the story development, achieving the multi-modal human-computer interaction effect, and creating an immersive aesthetic education experience environment in Song Dynasty for children. The story plot is enriched through multi-modal human-computer interaction and artificial intelligence plot generation technology, making each game experience unique. Meanwhile, the sense of participation of the children can be enhanced by means of a mystery-themed game and a voice interaction mode. Support for customizing game plots allows the children to create unique and personalized stories while playing, and personalized creative needs are satisfied.

In an exemplary embodiment, the present disclosure further provides a computer device, including a memory and a processor. A computer program is stored in the memory, and the processor, when executing the computer program, implements the method above.

In an exemplary embodiment, the present disclosure further provides a computer readable storage medium, having a computer program stored therein. The computer program, when executed by a processor, implements the method above.

In an exemplary embodiment, the present disclosure further provides a computer program product, including a computer program. The computer program, when executed by a processor, implements the method above.

It should be noted that the user information (including, but not limited to, user equipment information, user personal information, etc.) and data (including, but not limited to, data for analysis, stored data, displayed data, etc.) involved in the present disclosure are all information and data authorized by the user or fully authorized by all parties, and the collection, use and processing of relevant data need to comply with relevant regulations.

Those skilled in the art can understand that all or part of the processes in the embodiment method above can be completed by instructing related hardware through a computer program. The computer program can be stored in a non-volatile computer readable storage medium, and when executed, may include the processes of the embodiments of the method above. Any reference to the memory, database or other media used in the embodiments provided in the present disclosure may include at least one of a non-volatile memory and a volatile memory. The non-volatile memory may include a read only memory (ROM), a magnetic tape, a floppy disk, a flash memory, an optical memory, a high-density embedded non-volatile memory, a resistive random access memory (ReRAM), a magneto-resistive random access memory (MRAM), a ferroelectric random access memory (FRAM), a phase change memory (PCM), a graphene memory, etc. The volatile memory may include a random access memory (RAM), or an external cache memory, etc. By way of illustration than limitation, RAM may be in various forms, such as a static random access memory (SRAM) or a dynamic random access memory (DRAM).

The database involved in each embodiment provided by the present disclosure may include at least one of a relational database and a non-relational database. The non-relational database may include, but is not limited to, a distributed database based on a block chain. The processor involved in each embodiment provided by the present disclosure may be, but is not limited to, a general processor, a central processing unit, a graphics processor, a digital signal processor, a programmable logic, a data processing logic based on quantum computing, etc.

The technical features of the above embodiments can be combined at will. To make the description concise, not all possible combinations of the technical features in the above embodiments are described. However, it should be considered that these combinations of technical features fall within the scope recorded in this specification provided that these combinations of technical features do not have any conflict.

Specific examples are used herein for illustration of the principles and embodiments of the present disclosure. The description of the embodiments is merely used to help illustrate the method and its core principles of the present disclosure. In addition, a person of ordinary skill in the art can make various modifications in terms of specific embodiments and scope of application in accordance with the teachings of the present disclosure. In conclusion, the content of this specification shall not be construed as a limitation to the present disclosure.

What is claimed is:

1. A method for generating a plot in a miniature theater intelligent machine, comprising:
performing word segmentation on a plot text at a current moment to generate a plurality of words, wherein the plot text comprises an educational story or game plotline, a plot category and personage dialogue corresponding to the plot category;
transforming the plurality of words by Bidirectional Encoder Representations from Transformers to generate word vectors corresponding to respective words;
setting the word vectors corresponding to the respective words as feature vectors corresponding to the plot text at the current moment; and
inputting the feature vectors corresponding to the plot text at the current moment and contextual information at the current moment into a trained deep learning model to determine a plot text at a next moment, wherein the contextual information at the current moment comprises a historical choice of a user at the current moment, an emotional state of a character at the current moment, and a real-time operation instruction of the user at the current moment, and the real-time operation instruction comprises a voice instruction and a touch instruction.

2. The method according to claim 1, further comprising: before the inputting the feature vectors corresponding to the plot text at the current moment and contextual information at the current moment into a trained deep learning model to determine a plot text at a next moment,
constructing a deep learning model;
wherein a training process of the deep learning model comprises:
generating a historical plot text at a starting moment by setting a historical choice of a historical user, an emotional state of a historical character and a real-time operation instruction of the historical user obtained at the starting moment as historical contextual information;
setting the historical plot text at the starting moment as the plot text at the current moment;
inputting feature vectors corresponding to the plot text at the current moment and the historical contextual information into the deep learning model to output a plot text at a next moment; and
training the deep learning model with a goal of minimizing a difference between a plot category of the plot text at the next moment and a real plot category corresponding to the real-time operation instruction of the historical user to obtain the trained deep learning model.

3. The method according to claim 2, further comprising: after the training the deep learning model with a goal of minimizing a difference between a plot category of the plot text at the next moment and a real plot category corresponding to the real-time operation instruction of the historical user to obtain the trained deep learning model,
acquiring a plot scene generated from the plot text at the next moment;
optimizing the plot scene based on a structural similarity index measure or a peak signal-to-noise ratio to determine an optimized plot scene; and
setting the optimized plot scene as a final plot scene.

4. The method according to claim 3, wherein the optimizing the plot scene based on a structural similarity index measure or a peak signal-to-noise ratio to determine an optimized plot scene comprises:
determining the structural similarity index measure based on a mean, a standard deviation and a covariance of the plot scene and a mean, a standard deviation and a covariance of an original plot scene structure, and maximizing the structural similarity index measure to determine the optimized plot scene;
or
determining the peak signal-to-noise ratio based on a maximum predetermined pixel value of the plot scene as well as a mean variance between the plot scene and an original plot scene structure, and maximizing the peak signal-to-noise ratio to determine the optimized plot scene.

5. The method according to claim 1, further comprising: before the performing word segmentation on a plot text at a current moment to generate a plurality of words,
performing denoising and normalization processing on the plot text at the current moment.

6. A apparatus for generating a plot in a miniature theater intelligent machine, comprising:
the miniature theater intelligent machine, configured to execute a method, wherein the miniature theater intelligent machine comprises a sensor and a loudspeaker, and the sensor is configured to sense an operation instruction of a user, and the loudspeaker is configured to play a sound effect in the plot;
a far infrared induction flashlight, provided with a card slot, wherein
the card slot is used for insertion of a character near field communication (NFC) card, and the character NFC card is used for storing character information, wherein the character information comprises personage dialogue, a scene corresponding to the personage dialogue, and personage information; and
the far infrared induction flashlight is configured to read the character NFC card to trigger a corresponding plot, and irradiate a personage on a screen of the miniature theater intelligent machine by a far infrared ray to trigger a plot text corresponding to the personage;
a projector, configured to project a plot scene corresponding to a plot text at the next moment generated by the miniature theater intelligent machine onto the screen; and
a power module, configured to supply power to the miniature theater intelligent machine, the far infrared induction flashlight, and the projector;
wherein the method comprises:
performing word segmentation on a plot text at a current moment to generate a plurality of words, wherein the plot text comprises an educational story or game plotline, a plot category and personage dialogue corresponding to the plot category;
transforming the plurality of words by Bidirectional Encoder Representations from Transformers to generate word vectors corresponding to respective words;
setting the word vectors corresponding to the respective words as feature vectors corresponding to the plot text at the current moment; and
inputting the feature vectors corresponding to the plot text at the current moment and contextual information at the current moment into a trained deep learning model to determine the plot text at the next moment, wherein the contextual information at the current moment comprises a historical choice of the user at the current moment, an emotional state of a character at the current moment, and a real-time operation instruction of the user at the current moment, and the real-time operation instruction comprises a voice instruction and a touch instruction.

7. The apparatus according to claim 6, further comprising a communication module, wherein
the communication module is arranged within the miniature theater intelligent machine;
the communication module is in wireless communicate with an external terminal for data transmission; and
the external terminal is configured for a user to send the real-time operation instruction.

8. The apparatus according to claim 6, wherein the method further comprises: before the inputting the feature vectors corresponding to the plot text at the current moment and contextual information at the current moment into a trained deep learning model to determine the plot text at the next moment,
constructing a deep learning model;
wherein a training process of the deep learning model comprises:
generating a historical plot text at a starting moment by setting a historical choice of a historical user, an emotional state of a historical character and a real-time operation instruction of the historical user obtained at the starting moment as historical contextual information;
setting the historical plot text at the starting moment as the plot text at the current moment;
inputting feature vectors corresponding to the plot text at the current moment and the historical contextual information into the deep learning model to output a plot text at a next moment; and
training the deep learning model with a goal of minimizing a difference between a plot category of the plot text at the next moment and a real plot category corresponding to the real-time operation instruction of the historical user to obtain the trained deep learning model.

9. The apparatus according to claim 8, wherein the method further comprises: after the training the deep learning model with a goal of minimizing a difference between a plot category of the plot text at the next moment and a real plot category corresponding to the real-time operation instruction of the historical user to obtain the trained deep learning model,
acquiring a plot scene generated from the plot text at the next moment;
optimizing the plot scene based on a structural similarity index measure or a peak signal-to-noise ratio to determine an optimized plot scene; and
setting the optimized plot scene as a final plot scene.

10. The apparatus according to claim 9, wherein the optimizing the plot scene based on a structural similarity index measure or a peak signal-to-noise ratio to determine an optimized plot scene comprises:
determining the structural similarity index measure based on a mean, a standard deviation and a covariance of the plot scene and a mean, a standard deviation and a covariance of an original plot scene structure, and maximizing the structural similarity index measure to determine the optimized plot scene;
or
determining the peak signal-to-noise ratio based on a maximum predetermined pixel value of the plot scene as well as a mean variance between the plot scene and an original plot scene structure, and maximizing the peak signal-to-noise ratio to determine the optimized plot scene.

11. The apparatus according to claim 6, wherein the method further comprises: before the performing word segmentation on a plot text at a current moment to generate a plurality of words,
performing denoising and normalization processing on the plot text at the current moment.

12. A computer device, comprising:
a memory,
a processor, and
a computer program, stored in the memory and executable on the processor, wherein the processor, when executing the computer program, implements a method;
wherein the method comprises:
performing word segmentation on a plot text at a current moment to generate a plurality of words, wherein the plot text comprises an educational story or game plotline, a plot category and personage dialogue corresponding to the plot category;
transforming the plurality of words by Bidirectional Encoder Representations from Transformers to generate word vectors corresponding to respective words;
setting the word vectors corresponding to the respective words as feature vectors corresponding to the plot text at the current moment; and
inputting the feature vectors corresponding to the plot text at the current moment and contextual information at the current moment into a trained deep learning model to determine a plot text at a next moment, wherein the contextual information at the current moment comprises a historical choice of a user at the current moment, an emotional state of a character at the current moment, and a real-time operation instruction of the user at the current moment, and the real-time operation instruction comprises a voice instruction and a touch instruction.

13. The computer device according to claim 12, wherein the method further comprises: before the inputting the feature vectors corresponding to the plot text at the current moment and contextual information at the current moment into a trained deep learning model to determine a plot text at a next moment,
constructing a deep learning model;
wherein a training process of the deep learning model comprises:
generating a historical plot text at a starting moment by setting a historical choice of a historical user, an emotional state of a historical character and a real-time operation instruction of the historical user obtained at the starting moment as historical contextual information;
setting the historical plot text at the starting moment as the plot text at the current moment;
inputting feature vectors corresponding to the plot text at the current moment and the historical contextual information into the deep learning model to output a plot text at a next moment; and
training the deep learning model with a goal of minimizing a difference between a plot category of the plot text at the next moment and a real plot category corresponding to the real-time operation instruction of the historical user to obtain the trained deep learning model.

14. The computer device according to claim 13, wherein the method further comprises: after the training the deep learning model with a goal of minimizing a difference between a plot category of the plot text at the next moment and a real plot category corresponding to the real-time operation instruction of the historical user to obtain the trained deep learning model,
acquiring a plot scene generated from the plot text at the next moment;
optimizing the plot scene based on a structural similarity index measure or a peak signal-to-noise ratio to determine an optimized plot scene; and
setting the optimized plot scene as a final plot scene.

15. The computer device according to claim 14, wherein the optimizing the plot scene based on a structural similarity index measure or a peak signal-to-noise ratio to determine an optimized plot scene comprises:
determining the structural similarity index measure based on a mean, a standard deviation and a covariance of the plot scene and a mean, a standard deviation and a covariance of an original plot scene structure, and maximizing the structural similarity index measure to determine the optimized plot scene;
or
determining the peak signal-to-noise ratio based on a maximum predetermined pixel value of the plot scene as well as a mean variance between the plot scene and an original plot scene structure, and maximizing the peak signal-to-noise ratio to determine the optimized plot scene.

16. The computer device according to claim 12, wherein the method further comprises: before the performing word segmentation on a plot text at a current moment to generate a plurality of words,
performing denoising and normalization processing on the plot text at the current moment.

17. A non-transitory computer readable storage medium, having a computer program stored therein, wherein the computer program, when executed by a processor, implements the method according to claim 1.

18. The non-transitory computer readable storage medium according to claim 17, wherein the method further comprises: before the inputting the feature vectors corresponding to the plot text at the current moment and contextual information at the current moment into a trained deep learning model to determine a plot text at a next moment,
constructing a deep learning model;
wherein a training process of the deep learning model comprises:
generating a historical plot text at a starting moment by setting a historical choice of a historical user, an emotional state of a historical character and a real-time operation instruction of the historical user obtained at the starting moment as historical contextual information;
setting the historical plot text at the starting moment as the plot text at the current moment;
inputting feature vectors corresponding to the plot text at the current moment and the historical contextual information into the deep learning model to output a plot text at a next moment; and
training the deep learning model with a goal of minimizing a difference between a plot category of the plot text at the next moment and a real plot category corresponding to the real-time operation instruction of the historical user to obtain the trained deep learning model.

19. The non-transitory computer readable storage medium according to claim 18, wherein the method further comprises: after the training the deep learning model with a goal of minimizing a difference between a plot category of the plot text at the next moment and a real plot category corresponding to the real-time operation instruction of the historical user to obtain the trained deep learning model,
acquiring a plot scene generated from the plot text at the next moment;
optimizing the plot scene based on a structural similarity index measure or a peak signal-to-noise ratio to determine an optimized plot scene; and
setting the optimized plot scene as a final plot scene.

20. The non-transitory computer readable storage medium according to claim 19, wherein the optimizing the plot scene based on a structural similarity index measure or a peak signal-to-noise ratio to determine an optimized plot scene comprises:
determining the structural similarity index measure based on a mean, a standard deviation and a covariance of the plot scene and a mean, a standard deviation and a covariance of an original plot scene structure, and maximizing the structural similarity index measure to determine the optimized plot scene;
or
determining the peak signal-to-noise ratio based on a maximum predetermined pixel value of the plot scene as well as a mean variance between the plot scene and an original plot scene structure, and maximizing the peak signal-to-noise ratio to determine the optimized plot scene.
